(19) United States
(12) Patent Application Publication
(10) Pub. No.: US 2019/0206346 A1
(43) Pub. Date: Jul. 4, 2019

(54) DISPLAY APPARATUS

(71) Applicant: Au Optronics Corporation, Hsinchu (TW)

(72) Inventors: Peng-Bo Xi, Taipei City (TW); Sung-Yu Su, Tainan City (TW)

(73) Assignee: Au Optronics Corporation, Hsinchu (TW)

(21) Appl. No.: 16/118,447

(22) Filed: Aug. 31, 2018

(30) Foreign Application Priority Data
Dec. 29, 2017 (TW) 106146437

(51) Int. Cl. G09G 3/36; G02F 1/1335

(52) U.S. Cl. CPC G09G 3/3614; G02F 1/133514; G09G 3/3655; G09G 2300/0426; G09G 3/3685; G09G 2330/021; G09G 3/3674

(57) ABSTRACT

A display apparatus is provided. In a column inversion driving mode, adjacent pixels in an extension direction of scan lines are driven to have the same polarity, so as to reduce the power consumption of the display apparatus and prevent light leakage occurring at a junction of two adjacent pixels. Therefore, the display quality of the display apparatus is enhanced.

### CROSS-REFERENCE TO RELATED APPLICATION

This application claims the priority benefit of Taiwan application serial no. 106146437, filed on Dec. 29, 2017. The entirety of the above-mentioned patent application is hereby incorporated by reference herein and made a part of this specification.

### BACKGROUND OF THE INVENTION

### 1. Field of the Invention

The disclosure relates to an electronic device and particularly relates to a display apparatus.

### 2. Description of Related Art

To meet the requirements of a modern product such as high speed, high performance, light weight and a small size, all electronic devices are being developed toward small volume progressively. Various portable electronic devices have also increasingly become mainstream, such as a note book, a cell phone, a digital dictionary, a personal digital assistant, a web pad and a tablet PC, and the like. For the image display panel of the portable electronic device, in order to meet the requirements of a product for small size, a liquid crystal display panel including remarkable properties such as high space utilization, high resolution, low power consumption and zero irradiation is being used widely at present.

The rotation direction of a liquid crystal is associated with an electric field provided for the liquid crystal. In order to remove direct current residual voltages stored in the liquid crystal and prevent the polarization of the liquid crystal, the liquid crystal can be driven through a polarity inversion driving method. In other words, driving voltages with different polarities (such as positive and negative polarities) are provided for pixels alternately during different frame periods. The polarity inversion driving method includes the types of column inversion, row inversion, frame inversion and dot inversion.

In terms of these polarity inversion driving methods, the liquid crystal display device driven through the dot inversion driving method exhibits desirable display quality. However, in the conventional dot inversion driving method, a data line actuator provides driving voltages with positive and negative polarities for every driving pathway during two consecutive scanning periods to allow two adjacent pixels to have different polarities. A high voltage swing between positive and negative voltages lead to an increase in the power consumption of the data line actuator. In addition, since the two adjacent pixels in an extension direction of scan lines have opposite polarities, an electric field generated at a junction of the two adjacent pixels contributes to light leakage for the liquid crystal display panel. For this reason, display quality become poorer. In addition, in case of a liquid crystal display device using the column inversion driving method, since the data line actuator provides driving voltages with the same polarity during different scanning periods, the power consumption can decrease. However, there is still a problem of light leakage with the liquid crystal display panel.

### SUMMARY OF THE INVENTION

The display apparatus according to one embodiment of the disclosure includes a scan line driving circuit, a data line driving circuit and a pixel array. The pixel array has a plurality of pixel units. Each of the pixel units includes a scan line, six data lines, a first common electrode, three first pixels, a second common electrode and three second pixels. The scan line is coupled to the scan line driving circuit. The six data lines are coupled to the data line driving circuit and disposed parallel to each other substantially in a first direction. The adjacent data lines provide data voltages of different polarities. The first common electrode is configured to receive a common voltage of a first polarity. The three first pixels are disposed in a first row and a first line, the first row and a second line, and a second row and a first line in the pixel unit. Each of the three first pixels includes a first transistor that has a first end, a second end and a control end. The first end is coupled to the data line to which each of the first pixels corresponds, and the control end is coupled to the data line. The second common electrode is configured to receive a common electrode of a second polarity. The three second pixels are disposed in the first row and a third line, the second row and a second line, and the second row and a third line in the pixel unit. Each of the three second pixels includes a second transistor that has a first end, a second end and a control end. The first end is coupled to the data line to which each of the second pixels corresponds, the second end is electrically coupled to the second common electrode, and the control end is coupled to the scan line. The second end of a transistor to which pixels in the first row of each of the pixel units correspond is electrically coupled to the first common electrode, and the second end of the transistor to which pixels in the second row of each of the pixel units correspond is electrically coupled to the second common electrode.

According to one embodiment of the disclosure, the transistor to which the pixels in the first row of each of the pixel units correspond receives the data voltage of the first polarity, and the transistor to which the pixels in the second row of each of the pixel units correspond receives the data voltage of the second polarity.

According to one embodiment of the disclosure, the three first pixels display a first color, a second color or a third color respectively, and the three second pixels also display the first color, the second color or the third color respectively. Any two of the adjacent pixels in each of the pixel units are configured to display different colors.

According to one embodiment of the disclosure, at least one of the two adjacent pixel units in a second direction shares the first common electrode or the second common electrode.

According to one embodiment of the disclosure, the two adjacent pixels sharing the first common electrode or the second common electrode in the second direction are configured to display different colors.

According to one embodiment of the disclosure, in the same frame, a polarity of data voltages provided by each of the data lines is unchanged.

According to one embodiment of the disclosure, in each of the pixel units, the two adjacent data lines are configured to receive the data voltage with different polarities.

The display apparatus according to one embodiment of the disclosure includes a scan line driving circuit, a data line driving circuit and a pixel array. The pixel array has a plurality of pixel units. Each of the pixel units includes a scan line, six data lines, a first common electrode, a second common electrode and six second electrodes. The scan line is coupled to the scan line driving circuit. The six data lines are coupled to the data line driving circuit and disposed parallel to each other substantially in a first direction. The first common electrode and the second common electrode extend in the first direction respectively. A transistor to which three pixels in the first row of the pixel unit correspond is coupled to the scan line, the first common electrode and the corresponding data line. A transistor to which the three pixels in the second row of the pixel unit is coupled to the scan line, the second common electrode and the corresponding data line. Any two of the adjacent pixels in the pixel unit correspond to color filters of different colors.

According to one embodiment of the disclosure, in each of the pixel units, the scan line is located between the first common electrode and the second common electrode.

According to one embodiment of the disclosure, in each of the pixel units, when any one of the pixels in the first row is coupled to the data line of a first polarity located on a first side of the pixel, another pixel adjacent to the pixel in the second row is coupled to the data line of a second polarity on the first side, and the two adjacent pixels sharing the first common electrode or the second common electrode in a second direction are configured to display different colors.

According to one embodiment of the disclosure, in the two adjacent pixel units in a second direction, the two first common electrodes or the two first second common electrodes are connected to each other.

According to one embodiment of the disclosure, a transistor to which two adjacent pixels in each of the pixel units in a second direction correspond is located between the data lines to which the two adjacent pixels correspond.

The display apparatus according to one embodiment of the disclosure includes a scan line driving circuit, a data line driving circuit, a pixel array, a plurality of data lines, a plurality of scan lines, a plurality of first common electrodes and a plurality of second common electrodes. The pixel array has a plurality of pixels. The plurality of data lines are coupled to the data line driving circuit and arranged in a first direction. The plurality of scan lines are coupled to the scan line driving circuit and arranged in a second direction. The plurality of first common electrodes extend in the first direction. The plurality of second common electrodes extend in the first direction, and the first common electrode and the second common electrode are arranged alternately in the second direction. The two adjacent pixels in the first direction can correspond to the same first common electrode or the same second common electrode, and each of the pixels merely corresponds to the first common electrode or the second common electrode.

According to one embodiment of the disclosure, in two adjacent pixels coupled to the same scan line in the second direction, one of the pixels corresponds to the first common electrode, while the other of the pixels corresponds to the second common electrode.

According to one embodiment of the disclosure, the display apparatus further includes a color filter that is arranged corresponding to each of the pixels. Two adjacent pixels coupled to the same common electrode in the second direction correspond to the color filter of the same color.

According to one embodiment of the disclosure, the display apparatus further includes the color filter that is arranged corresponding to each of the pixels. Two adjacent pixels coupled to the same scan line in the second direction correspond to the color filter of different colors.

According to one embodiment of the disclosure, a width of one of the first common electrodes differs from a width of one of the second common electrodes.

In view of the foregoing, in the column inversion driving method, a pixel structure of the pixel array according to the embodiments of the disclosure can allow the adjacent pixels in the extension direction of the scan line to have the same polarity to reduce the power consumption of the display apparatus and prevent light leakage from occurring at a junction of the two adjacent pixels. For this reason, the display quality of the display apparatus can be enhanced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display apparatus according to an embodiment of the disclosure.

FIG. 2 is a configuration diagram illustrating pixels and common electrodes corresponding to the display apparatus according to the embodiment of FIG. 1.

FIG. 3 is a schematic view of another display apparatus according to an embodiment of the disclosure.

FIG. 4 is a configuration diagram illustrating pixels and common electrodes corresponding to the display apparatus according to the embodiment of FIG. 3.

FIG. 5 is a schematic view of another display apparatus according to an embodiment of the disclosure.

FIG. 6 is a configuration diagram illustrating pixels and common electrodes corresponding to the display apparatus according to the embodiment of FIG. 5.

FIG. 7 is another configuration diagram illustrating pixels and common electrodes according to the embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

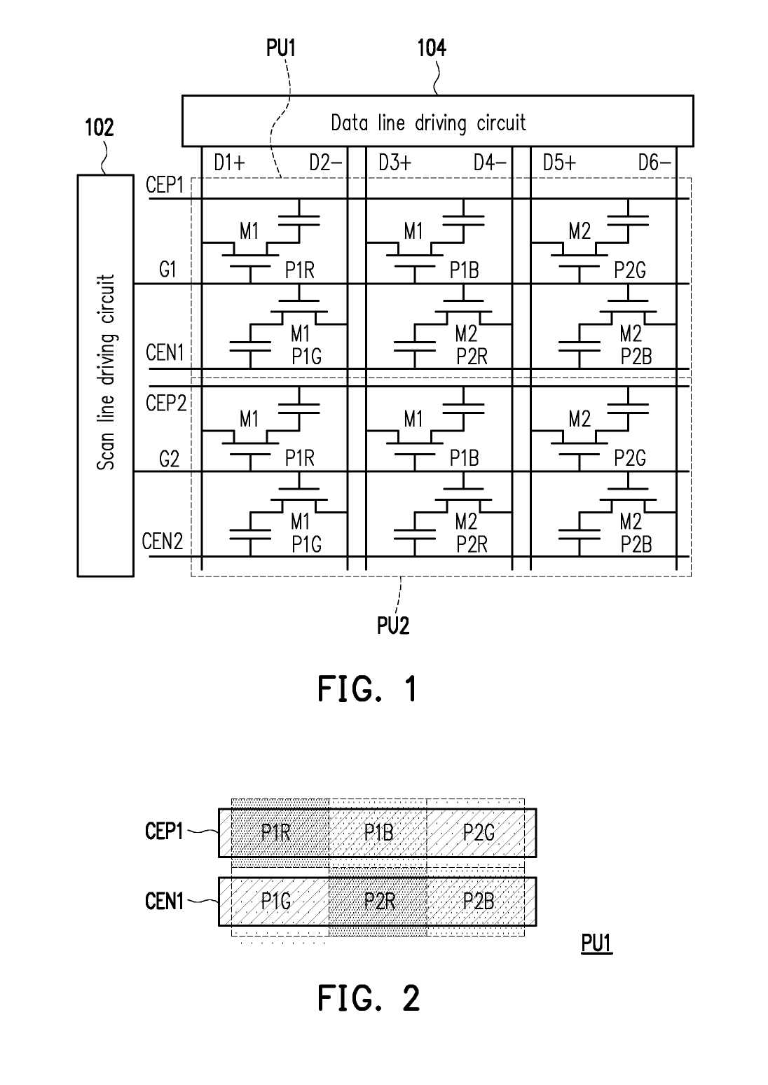

FIG. 1 is a schematic view of a display apparatus according to an embodiment of the disclosure. Referring to FIG. 1, the display apparatus may be, for example, a liquid crystal display apparatus including a scan line driving circuit 102, a data line driving circuit 104 and a pixel array. Furthermore, the pixel array may include a plurality of scan lines, a plurality of data lines, a plurality of first common electrodes, a plurality of second common electrodes and a plurality of pixel units. The embodiment of FIG. 1 merely shows scan lines G1 and G2, data lines D1+ through D6−, first common electrodes CEP1 and CEP2, second common electrodes CEN1 and CEN2 and pixel units PU1 and PU2, but the numbers of the scan lines, the data lines, the first common electrodes, the second common electrodes and the pixel units included by the pixel array are not limited thereto. In the embodiment of the disclosure, the data lines D1+ through D6− are disposed parallel to each other substantially (the case of the data lines D1+ through D6− may be that D1+ through D6− are disposed in parallel in a linear direction or a non-linear direction) in an extension direction (i.e., a first direction) of the scan line (such as G1). The adjacent data lines are configured to provide data voltages of different polarities. For example, the data lines D1+, D3+ and D5+ can be configured to provide the data voltages of a positive polarity, while the data lines D2−, D4− and D6− can be configured to provide the data voltages of a negative polarity. In addition, the scan lines G1 and G2 are disposed in a second direction, and the first common electrodes CEP1 and CEP2 and the second common electrodes CEN1 and CEN2 extend in the first direction. The first common electrodes CEP1 and CEP2 and the second common electrodes CEN1 and CEN2 are disposed alternately in the second direction to allow one of the two adjacent pixels in the second direction to correspond to the first common electrode and allow the other of the two adjacent pixels in the second direction to correspond to the second common electrode. The first common electrodes CEP1 and CEP2 are configured to provide a common voltage of a first polarity (such as the positive polarity), while the second common electrodes CEN1 and CEN2 are configured to provide a common voltage of a second polarity (such as the negative polarity).

Each of the pixel units can include three first pixels and three second pixels. The three first pixels in each of the pixel units are disposed in a first row and a first line, the first row and a second line, and a second row and a first line of the corresponding pixel unit, and the three second pixels are disposed in the first row and a third line, the second row and a second line and the second row and a third of in the corresponding pixel unit. The pixel unit PU1, for example, may include three first pixels P1R, P1B and P1G and three second pixels P2G, P2R and P2B. The three first pixels P1R, P1B and P1G are disposed in the first row and the first line, the first row and the second line and the second row and the first line of the pixel unit PU1, while the three second pixels P2G, P2R and P2B are disposed in the first row and the third line, the second row and the second line and the second row and the third line of the pixel unit PU1. Each of the first pixels P1R, P1B and P1G includes a transistor M1. A first end of the transistor M1 is coupled to the corresponding data line, and a control end of the transistor M1 is coupled to the corresponding data line. Each of the second pixels P2G, P2R and P2B includes a transistor M2. A first end of the transistor M2 is coupled to the corresponding data line, and a control end of the transistor M2 is coupled to the corresponding scan line. In addition, the second end of the transistor to which the pixel in the first row of the pixel unit PU1 corresponds is electrically coupled to the first common electrode, and the second of the transistor to which the pixel in the second row of the pixel unit PU1 corresponds is electrically coupled to the second common electrode.

For example, in the pixels in the first row of the pixel unit PU1, a first end of the first pixel P1R is coupled to the data line D1+a second end is electrically coupled to the first common electrode CEP1 through capacitance, and a control end is coupled to the scan line G1; a first end of the first pixel P1B is coupled to the data line D3+, a second end is electrically coupled to the first common electrode CEP1 through capacitance, and a control end is coupled to the scan line G1; a first end of the second pixel P2G is coupled to the data line D5+, a second end is electrically coupled to the first common electrode CEP1 through capacitance, and a control end is coupled to the scan line G1. Similarly, in the pixels in the second row of the pixel unit PU1, a first end of the first pixel P1G is coupled to the data line D2−, a second end is electrically coupled to the second common electrode CEN1 through capacitance, and a control end is coupled to the scan line G1; a first end of the second pixel P2R is coupled to the data line D4−, a second end is electrically coupled to the second common electrode CEN1 through capacitance, and a control end is coupled to the scan line G1; a first end of the second pixel P2B is coupled to the data line D6−, a second end is electrically coupled to the second common electrode CEN1 through capacitance, and a control end is coupled to the scan line G1. In addition, the transistor to which the two adjacent pixels in each of the pixel units in the second direction correspond is disposed between the data lines to which the two adjacent pixels correspond. For example, in the pixel unit PU1, the first pixels P1R and P1G are adjacent to each other in the second direction, and the transistor M1 of the first pixel P1R and the transistor M1 of the first pixel P1G are disposed between the data line D1+ to which the first pixel P1R corresponds and the data line D2− to which the first pixel P1G corresponds. Among the rest of the pixels in the pixel unit PU1, the two adjacent pixels in the second direction are also coupled to each other in a similar way. In addition, the first pixel and the second pixel in the pixel unit PU2 are coupled to each other in a similar way to the way that the first pixel and the second pixel in the pixel unit PU1 are coupled to each other. Therefore, a detailed description is omitted.

In the embodiment, the display apparatus includes a first substrate, a second substrate and a display element. The display element is sandwiched between the first substrate and the second substrate. For example, the display apparatus may be a liquid crystal display device. The first substrate may be a color filter substrate, the second substrate may be a pixel array substrate, and the display element may be a liquid crystal element. Specifically, the first common electrode CEP1 and the second common electrode CEN1 are disposed on the color filter substrate and overlap with the corresponding pixels. According to the configuration diagram of FIG. 2 illustrating pixels and common electrodes, the pixel unit includes the first pixels P1R, P1B and P1G and the second pixels P2G, P2R and P2B respectively. Take the pixel unit PU1 as an example, the first common electrode CEP1 may be disposed in the first pixels P1R and P1B and the second pixel P2G correspondingly, and the second common electrode CEN1 may be disposed in the first pixel P1G and the second pixels P2R and P2B correspondingly.

In the embodiment, the three first pixels included by each of the pixel units may display a first color, a second color or a third color respectively. The three second pixels may also display the first color, the second color or the third color respectively. Any two of the adjacent pixels in each of the pixel units are configured to display different colors. For example, in the pixel unit PU1, the first pixels P1R, P1B and P1G are configured to display red, blue and green colors respectively, and the second pixels P2G, P2R and P2B are configured to display green, red and blue colors respectively. Any two of the adjacent pixels in the pixel unit PU1 display different colors. Furthermore, the colors of each of the first pixels and each of the second pixels are displayed by the color filter on the color filter substrate. For example, the first pixels P1R, P1B and P1G in the pixel unit PU1 may be disposed corresponding to portions in red, blue and green colors of the color filter, and the second pixels P2G, P2R and P2B may be disposed corresponding to portions in green, red and blue colors of the color filter. In this way, the light passing through the pixels can be filtered by the color filter covered on the pixels to display the corresponding color.

In the embodiment, the transistors to which the pixels P1R, P1B and P2G in the first row of the pixel unit PU1 may receive the data voltage of the first polarity (such as the positive polarity) through the corresponding data lines D1+, D3+ and D5+. Meanwhile, the first common electrode CEP1 provides the common voltage of the first polarity for the pixels P1R, P1B and P2G to drive the pixels P1R, P1B and P2G to display image screens. In addition, the transistors to which the pixels P1G, P2R and P2B in second row of the pixel unit PU1 may receive the data voltage of the second polarity (such as negative polarity) through the corresponding data lines D2−, D4− and D6−. Meanwhile, the second common electrode CEN1 provides the common voltage of the second polarity for the pixels P1G, P2R and P2B to drive the pixels P1G, P2R and P2B to display image screens. The data voltages of the same polarity may have different voltage values to allow the pixels to display different grayscale values. Similarly, the first and second pixels in the pixel unit PU2 may also be driven in a similar way. A detailed description is omitted. Since each of the data lines D1+ through D6− provides data voltages of unchanged polarities, which means the data lines D1+ through D6− may be driven through the conventional technique of column inversion driving method, and the adjacent pixels on the extension direction (the first direction) of the scan line have common voltages of the same polarity, the display apparatus according to the embodiment of the disclosure can be configured to address the problem of light leakage caused by the different polarities of the adjacent pixels for the conventional technique while reducing the power consumption. In addition, since any two of the adjacent pixels are configured to display different colors, the resolution of a screen is not influenced, and the display quality of the display apparatus can be effectively enhanced.

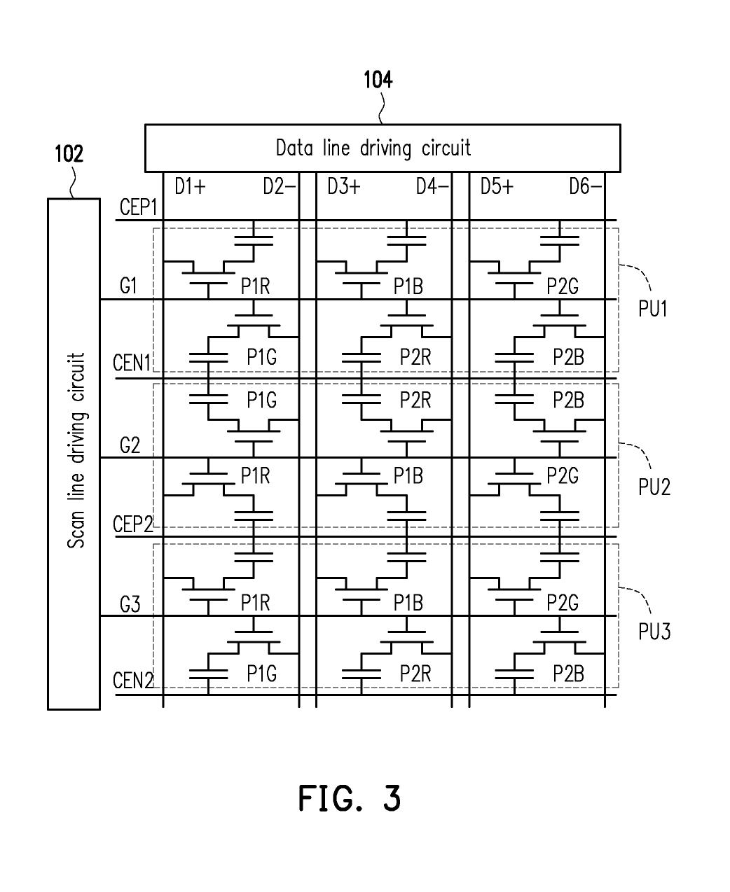

FIG. 3 is a schematic view of another display device according to an embodiment of the disclosure. Referring to FIG. 3, the difference between the display device according to the embodiment of the disclosure and the display device according to the embodiment of FIG. 1 is that the two adjacent pixel units on the extension direction (i.e., the second direction) of the data line may share the first common electrode or the second common electrode. In addition, the pixels sharing the first common electrode or the second common electrode are configured to display the same color. In other words, the two adjacent pixels in the second direction correspond to the color filter of the same color. For example, in the embodiment, the first pixels P1G and the second pixels P2R and P2B (which are configured to display green, red and blue colors respectively) of the pixel unit PU1 may share the second common electrode CEN1 with the first pixel P1G and the second pixels P2R and P2B (which are configured to display green, red and blue colors respectively) of the pixel unit P1J2, and the first pixels P1R and P1B and the second pixel P2G (which are configured to display red, blue and green colors respectively) of the pixel unit PU2 may share the first common electrode CEP2 with the first pixels P1R and P1B and the second pixel P2G (which are configured to display red, blue and green colors respectively) of a pixel unit PU3. Likewise, the first pixel P1G and the second pixels P2R and P2B of the pixel unit PU3 may also share the second common electrode CEN2 with the pixels adjacent to the first pixel P1G and the second pixels P2R and P2B in the adjacent pixel unit.

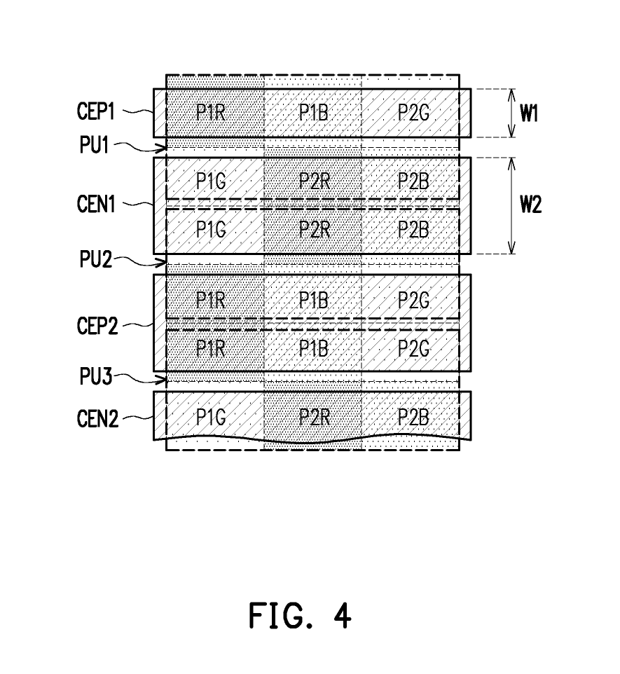

In addition, according to the configuration diagram of FIG. 4 showing pixels and common electrodes, in the embodiment, the shared common electrode has a larger width. For example, in FIG. 4, a width W2 of the second common electrode CEN1 shared by the pixels P1G, P2R and P2B of the pixel unit PU1 and the pixels P1G, P2R and P2B of the pixel unit PU2 is larger than a width W1 of the first common electrode used by the pixels P1R, P1B and P2G of the pixel unit PU1. The second common electrode CEN1 may be considered to be formed by connecting the second common electrode used by the pixels P1G, P2R and P2B of the pixel unit PU1 to the second common electrode used by the pixels P1G, P2R and P2B of the pixel unit PU2. Therefore, one of the two adjacent pixels in the second direction corresponds to the second common electrode, while the other of the two adjacent pixels in the second direction also corresponds to the same second common electrode. For example, the pixel P1G shares the second common electrode CEN1 with the pixel P1G. Similarly, the first common electrode CEP2 may be considered to be formed by connecting the first common electrode used by the second pixels P1G, P1R and P2B of the pixel unit PU2 to the first common electrode used by the first pixels P1G, P1R and P1B of the pixel unit PU3. Therefore, one of the two adjacent pixels in the second direction corresponds to the first common electrode, and the other of the two adjacent pixels in the second direction also corresponds to the same first common electrode. Likewise, the second common electrode CEN2 may also be shared by the pixel unit PU3 and the next pixel unit (not shown). The manner is as described in the above embodiment, so a detailed description is omitted.

In this way, in addition to reducing power consumption and addressing the problem of light leakage caused by different polarities of the adjacent pixels, allowing the two adjacent pixel units on the extension direction of the data line to share the first common electrode or the second common electrode can also elevate an aperture ratio of the display apparatus.

In the embodiment of FIG. 1, the pixels in each of the pixel units are arranged in the same way. For example, in the pixel unit P1, the pixels sequentially arranged in the first row are the pixels P1R, P1B and P2G, and the pixels sequentially arranged in the second row are the pixels P1G, P2R and P2B. In the pixel unit PU2, the pixels sequentially arranged the first row are also the pixels P1R, P1B and P2G, and the pixels sequentially arranged in the second row are the pixels P1G, P2R and P2B. Therefore, the pixels in each of the pixel units are arranged in the same way to create the same combinations of each color formed by each of the pixel units. In the embodiment of FIG. 3, the pixels located between the two adjacent pixel units in the second direction are arranged in mirror symmetry with a shaft extending in the first direction being a center. For example, the pixel units PU1 and PU2 are two adjacent pixel units in the second direction. It can be seen from FIG. 3 that the arrangement of the pixels of the pixel unit PU1 differs from the arrangement of the pixels of the pixel unit PU2. The pixels P1R, P1B and P2G are arranged in the first row of the pixel unit PU1, the pixels P1G, P2R and P2B are arranged in the second row of the pixel unit PU1, the pixels P1G, P2R and P2B are arranged in the first row of the pixel unit PU2, and the pixels P1R, P1B and P2G are arranged in the second row of the pixel unit PU2. At this moment, it can also be found that the arrangement of the pixels in the first row of the pixel unit PU1 is the same as the arrangement of the pixels in the second row of the pixel unit PU2, and the arrangement of the pixels in the second row of the pixel unit PU1 is the same as the arrangement of the pixels in the first row of the pixel unit PU2. In that case, the arrangement of the pixels of the pixel unit PU1 and the arrangement of the pixels of the pixel unit PU2 are shown in mirror symmetry with the second common electrode CEN1 being a center. Likewise, the arrangement of the pixels of the other pixel units (such as the pixel units PU2 and PU3) is also shown in mirror symmetry. A detailed description is omitted.

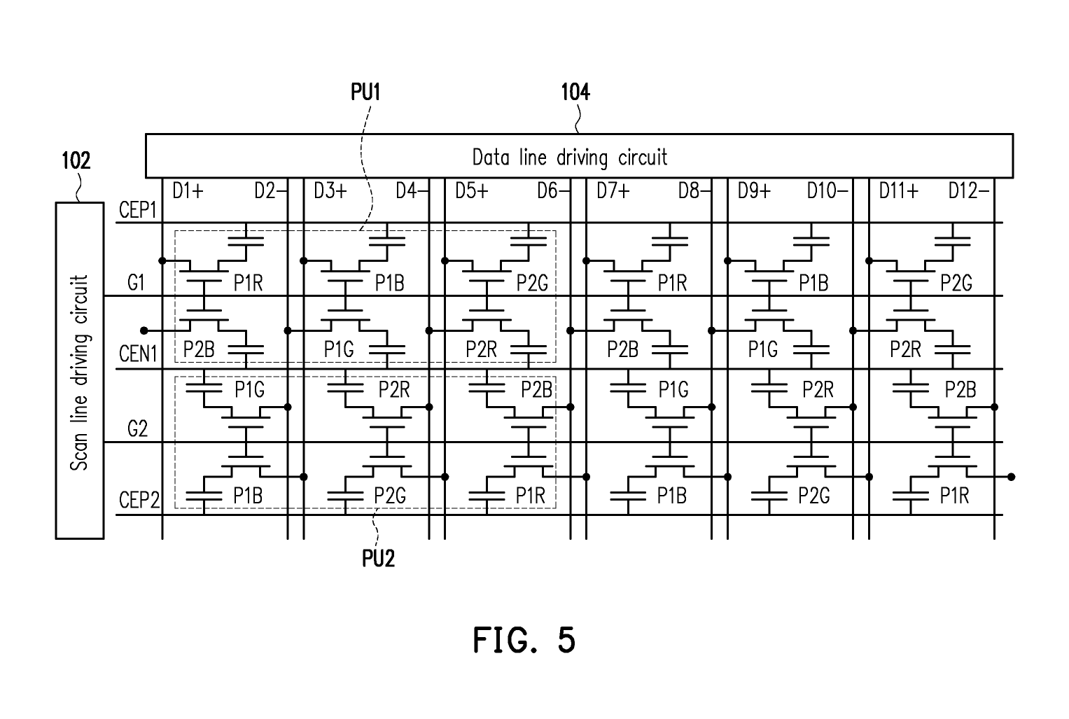

FIG. 5 is a schematic view of another display apparatus according to an embodiment of the disclosure. Referring to FIG. 5, the differences between the display apparatus according to the embodiment and the display apparatus according to the embodiment of FIG. 3 are that in each of the pixel units, when any one of the pixels in the first row is coupled to the data line of the first polarity on the first side of the pixel, another pixel adjacent to the pixel in the second row is coupled to the data line of the second polarity on the first side and that when any one of the pixels in the first row is coupled to the data line of the second polarity on the second side of the pixel, another pixel adjacent to the pixel in the second row is coupled to the data line of the first polarity on the second side. For example, in the pixel unit PU1, the first pixel P1B is coupled to the data line D3+ of the positive polarity on the left of the first pixel P1B, and the second pixel P1G adjacent to the first pixel P1B in the second direction is coupled to the data line D2− of the negative polarity located on the left of the second pixel P1G. Similarly, in the pixel unit PU2, the second pixel P2R is coupled to the data line D4− of the negative polarity on the right of the second pixel P2R, and the second pixel P2G adjacent to the first pixel P2R in the second direction is coupled to the data line D5+ of the positive polarity on the right of the second pixel P2G.

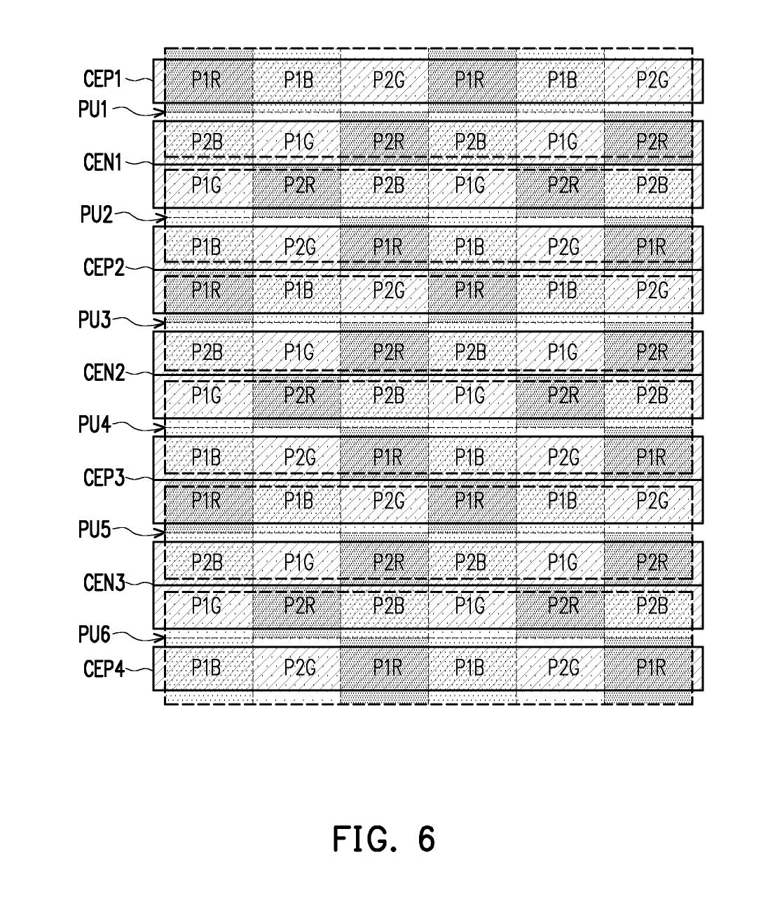

In addition, in the embodiment, the pixels sharing the first common electrode or the second common electrode may be configured to display different colors. In other words, the two adjacent pixels in the second direction correspond to the color filters of different colors to increase visual resolution. For example, in the embodiment, the second pixel P2B, the first pixel P1G and the second pixel P2R (which are configured to display blue, green and red colors respectively) of the pixel unit PU1 may share the second common electrode CEN1 with the first pixel P1G, the second pixel P2R and the first pixel P1B (which are configured to display green, red and blue colors respectively) of the pixel unit PU2. In addition, according to the configuration diagram of FIG. 6 showing pixels and common electrodes, in the embodiment, the shared common electrode may have a larger width. For example, in FIG. 6, the second common electrode CEN1 is shared by the second pixel P2B, the first pixel P1G and the second pixel P2R of the pixel unit PU1 and the first pixel P1G, the second pixel P2R and the second pixel P2B of the pixel unit PU2. Thus, a width of the second common electrode CEN1 is larger than a width of the first common electrode used by the first pixels P1R and P1B and the second pixel P2G of the pixel unit PU1. The second common electrode CEN1 can be considered to be formed by connecting the second common electrode used by the second pixel P2B, the first pixel P1G and the second pixel P2R of the pixel unit PU1 to the second common electrode used by the first pixel P1G and the second pixels P2R and P2B of the pixel unit PU2. Likewise, first common electrodes CEP2, CEP3 and CEP4 and second common electrodes CEN2 and CEN3 may also be shared by pixels to which the first common electrodes CEP2, CEP3 and CEP4 and the second common electrodes CEN2 and CEN3 correspond and therefore have a larger width.

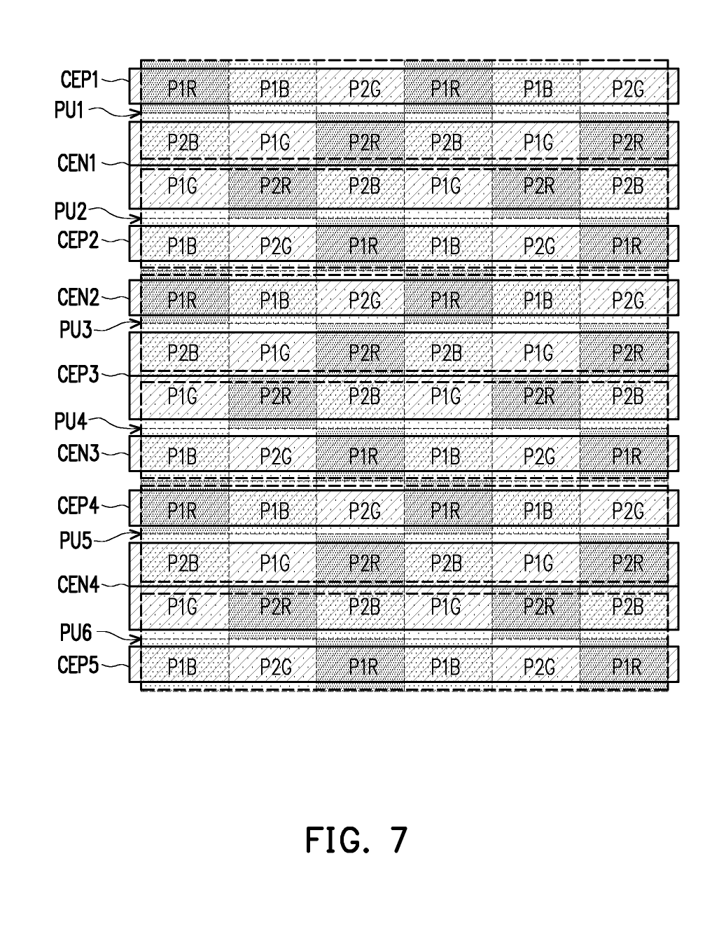

FIG. 7 is another configuration diagram illustrating pixels and common electrodes according to an embodiment of the disclosure. The difference between this embodiment and the embodiment of FIG. 6 is that every two pixel units in the second direction include a shared common electrode. In other words, every four rows of pixels include a shared common electrode. For example, the second common electrode CEN1 of FIG. 7 is shared by the second and third rows of the pixels, the first common electrode CEP3 is shared by the sixth and seventh rows of the pixels, and the second common electrode CEN4 is shared by the tenth and eleventh rows of the pixels. Furthermore, for example, the second pixel P2B, the first pixel P1G and the second pixel P2R (which are configured to display blue, green and red colors respectively) of the pixel unit PU1 share the second common electrode CEN1 with the first pixel P1G, the second pixel P2R and the second pixel P2B (which are configured to display green, red and blue colors respectively) of the pixel unit PU2 respectively. Other pixel units follow the similar rule, so a detailed description is omitted. In addition, similarly, a width of the common electrode shared by different pixel units is larger than a width of the common electrode that is not shared by different pixel units.

In view of the above, in the column inversion driving method, the pixel structure of the pixel array according to the embodiments of the disclosure may allow the adjacent pixels in the extension direction of the scan line to have the same polarity to reduce the power consumption of the display apparatus and prevent light leakage from occurring at the junction of the two adjacent pixels. Therefore, the display quality of the display apparatus can be enhanced. In some embodiments, the two adjacent pixel units in the extension direction of the data line may further be allowed to share the first common electrode or the second common electrode to reduce power consumption and address the problem of light leakage caused by different polarities of the adjacent pixels while enhancing the aperture ratio of the display apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display apparatus comprising:
a scan line driving circuit;
a data line driving circuit, providing a data voltage; and
a pixel array, having a plurality of pixel units, wherein each of the pixel units comprises:
a scan line, coupled to the scan line driving circuit;
six data lines, coupled to the data line driving circuit and disposed parallel to each other substantially in a first direction, the adjacent data lines providing data voltages of different polarities respectively;
a first common electrode, configured to receive a common voltage of a first polarity;
three first pixels, disposed in a first row and a first line, the first row and a second line and a second row and a first line of the pixel unit, each of the three first pixels comprising a first transistor having a first end, a second end and a control end, wherein the first end is coupled to the data line to which each of the first pixels corresponds, and the control end is coupled to the scan line;
a second common electrode, configured to receive a common voltage of a second polarity; and
three second pixels, disposed in the first row and a third line, the second row and a second line and the second row and a third line of the pixel unit, each of the three second pixels comprising a second transistor having a first end, a second end and a control end, wherein the first end is coupled to the data line to which each of the second pixels corresponds, the control end is coupled to the scan line, a second end of a transistor to which pixels in the first row of the pixel unit correspond is electrically coupled to the first common electrode, and a second end of a transistor to which pixels in the second row of the pixel unit correspond is electrically coupled to the second common electrode.

2. The display apparatus according to claim 1, wherein the transistor to which the pixels in the first row of each of the pixel units correspond receives the data voltage of the first polarity, and the transistor to which the pixels in the second row of each of the pixel units correspond receives the data voltage of the second polarity.

3. The display apparatus according to claim 1, wherein the three first pixels display a first color, a second color or a third color respectively, and the three second pixels display the first color, the second color or the third color respectively, wherein any two of adjacent pixels in each of the pixel units are configured to display different colors.

4. The display apparatus according to claim 1, wherein at least one of the two adjacent pixel units in a second direction shares the first common electrode or the second common electrode.

5. The display apparatus according to claim 4, wherein the two adjacent pixels sharing the first common electrode or the second common electrode in the second direction are configured to display different colors.

6. The display apparatus according to claim 1, wherein in the same frame, a polarity of the data voltage provided by each of the data lines is unchanged.

7. The display apparatus according to claim 1, wherein in each of the pixel units, two adjacent data lines are configured to receive the data voltage of different polarities.

8. A display apparatus comprising:
a scan line driving circuit;
a data line driving circuit; and
a pixel array, having a plurality of pixel units, wherein each of the pixel units comprises:
a scan line, coupled to the scan line driving circuit;
six data lines, coupled to the data line driving circuit and disposed parallel to each other substantially in a first direction;
a first common electrode;
a second common electrode, wherein the first common electrode and the second common electrode extend in the first direction respectively; and
six pixels, wherein a transistor to which three pixels in a first row of the pixel unit correspond is coupled to the scan line, the first common electrode and the corresponding data line, and a transistor to which three pixels in a second row of the pixel unit correspond is coupled to the scan line, the second common electrode and the corresponding data line, wherein any two of the adjacent pixels in the pixel unit correspond to color filters of different colors.

9. The display apparatus according to claim 8, wherein in each of the pixel units, the scan line is located between the first common electrode and the second common electrode.

10. The display apparatus according to claim 8, wherein in each of the pixel units, when any one of the pixels in the first row is coupled to the data line of a first polarity located on a first side of the pixel, another pixel adjacent to any one of the pixels in the second row is coupled to the data line of a second polarity located on the first side, and two adjacent pixels sharing the first common electrode or the second common electrode in a second direction are configured to display different colors.

11. The display apparatus according to claim 8, wherein in two adjacent pixel units in a second direction, the two first common electrodes or the two second common electrodes are connected to each other.

12. The display apparatus according to claim 8, wherein a transistor to which two adjacent pixels in each of the pixel units in a second direction correspond is located between the data lines to which the two adjacent pixels correspond.

13. A display apparatus comprising:
a scan line driving circuit;
a data line driving circuit;
a pixel array, having a plurality of pixels;
a plurality of data lines, coupled to the data line driving circuit and arranged in a first direction;
a plurality of scan lines, coupled to the scan line driving circuit and arranged in a second direction;
a plurality of first common electrodes, extending in the first direction; and
a plurality of second common electrodes, extending in the first direction, the first common electrodes and the second common electrodes being arranged alternately in the second direction,
wherein two adjacent pixels in the first direction correspond to the same first common electrode or the same second common electrode, and each pixel merely corresponds to the first common electrode or the second common electrode.

14. The display apparatus according to claim 13, wherein in two adjacent pixels coupled to the same scan line in the second direction, one of the pixels corresponds to the first common electrode, while the other of the pixels corresponds to the second common electrode.

15. The display apparatus according to claim 14, further comprising a color filter arranged corresponding to each of the pixels, wherein two adjacent pixels coupled to the same common electrode in the second direction correspond to the color filter of the same color.

16. The display apparatus according to claim 14, further comprising a color filter arranged corresponding to each of the pixels, wherein two adjacent pixels coupled to the same scan line in the second direction correspond to the color filter of different colors.

17. The display apparatus according to claim 13, wherein a width of one of the first common electrodes differs from a width of one of the second common electrodes.
